(19) United States
(12) Patent Application Publication
(10) Pub. No.: US 2014/0171192 A1
(43) Pub. Date: Jun. 19, 2014

(54) ELECTRONIC DEVICE AND METHOD FOR PROVIDING TACTILE STIMULATION

(71) Applicants: FU TAI HUA INDUSTRY (SHENZHEN) CO., LTD., Shenzhen (CN); HON HAI PRECISION INDUSTRY CO., LTD., New Taipei (TW)

(72) Inventor: SHANG-QING ZHOU, Shenzhen (CN)

(73) Assignees: HON HAI PRECISION INDUSTRY CO., LTD., New Taipei (TW); FU TAI HUA INDUSTRY (SHENZHEN) CO., LTD., Shenzhen (CN)

(21) Appl. No.: 13/729,025

(22) Filed: Dec. 28, 2012

(30) Foreign Application Priority Data
Dec. 13, 2012 (CN) 201210537346.6

(51) Int. Cl. A63F 13/02

(52) U.S. Cl. CPC A63F 13/02
USPC 463/31

(57) ABSTRACT

A method for providing tactile stimulation is applied in an electronic device. The electronic device includes a touch-sensitive screen and a tactile stimulation multilayer connected to the touch-sensitive screen. The tactile stimulation multilayer includes a number of electrodes. The method includes follow steps: displaying a number of game objects set by a game; determining each touched position of a slide operation; determining whether a first distance between one touched position and one target position is less than a predetermined distance; if yes, energizing the determined electrode corresponding to the touched position with a predetermined electrical parameter; determining whether a second distance between a new touched position and the target position is different from the first distance; if yes, altering the predetermined electronic parameter according to a difference between the first and the second distances; and energizing the electrode corresponding to the new touched position with the altered electrical parameter.

### BACKGROUND

1. Technical Field

The present disclosure relates to electronic devices, and particularly, to an electronic device and a method for providing tactile stimulation adapted for the electronic device.

2. Description of Related Art

Many electronic devices, such as mobile phones, tablet computers, and multimedia players, usually employ touch-sensitive screens as input interfaces. When a user plays a game installed in an electronic device having a touch-sensitive screen, he or she can select the virtual graphical icons displayed on the touch-sensitive screen to operate the game. However, the touch-sensitive screen do not provide very good tactile feedback to the user as a conventional keyboard does which has a travel distance for a keystroke when pressed and thus fails to improve the user experience when the user is operating the game.

Recently, a technology of enabling the touch-sensitive screen to provide tactile feedback is realized by delivering an electrosensory sensation in response to a touch operation on the touch-sensitive screen. However, there is less developments on how this kind of tactile feedback is applied with various games in an electronic device to bring a new level of tactile experience to the user when he or she is operating the games.

Therefore, what is needed is a means to solve the problem described above.

### BRIEF DESCRIPTION OF THE DRAWINGS

Many aspects of the present disclosure should be better understood with reference to the following drawings. The modules in the drawings are not necessarily drawn to scale, the emphasis instead being placed upon clearly illustrating the principles of the present disclosure. Moreover, in the drawings, like reference numerals designate corresponding portions throughout the views.

FIG. 1 is a perspective view of a touch-sensitive screen included in an electronic device, in accordance with an exemplary embodiment.

FIG. 2 is a perspective view of a tactile stimulation multilayer connected to the touch-sensitive screen of FIG. 1, in accordance with an exemplary embodiment.

FIG. 3 is a block diagram of a tactile stimulation system applied to the electronic device of FIG. 1, in accordance with an exemplary embodiment.

FIG. 4 is a flowchart of a method for providing tactile stimulation, in accordance with an exemplary embodiment.

### DETAILED DESCRIPTION

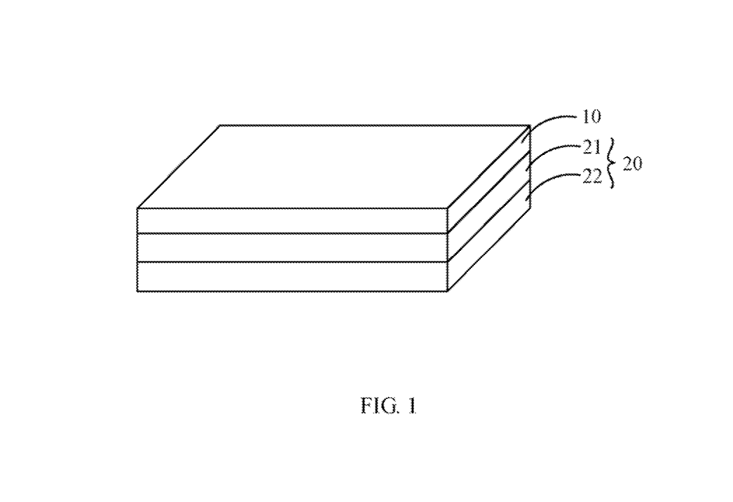

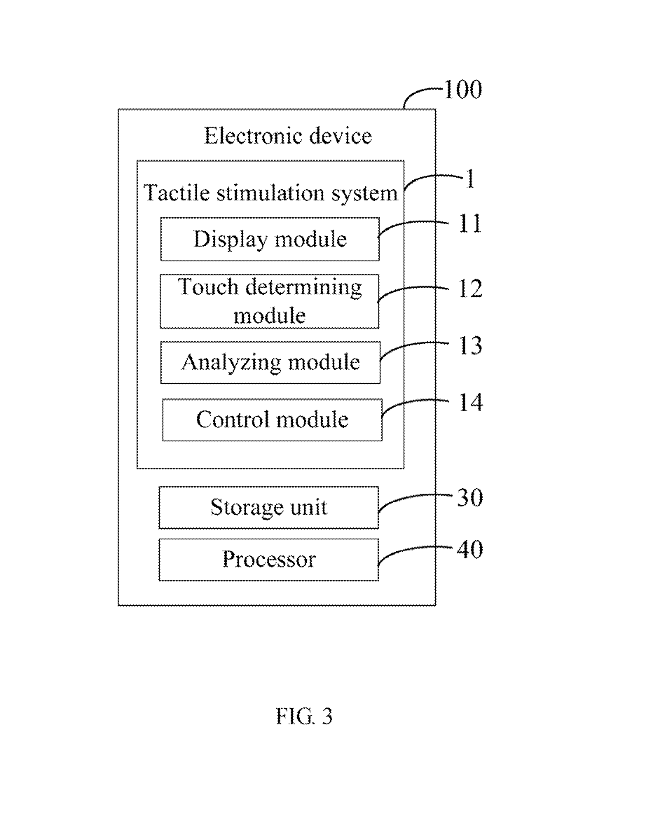

FIG. 1 is a perspective view of a touch-sensitive screen 10 of an electronic device 100 according to an exemplary embodiment. The electronic device 100 may be a mobile phone, a tablet computer, or a multimedia player for example. At least one game is installed on the electronic device 100. A tactile stimulation multilayer 20 is connected to the screen 10, and is arranged above or under the screen 10. The multilayer 20 includes a number of electrodes 220 (further shown in FIG. 3) which can be independently controlled. The electronic device 100 further includes a storage unit 30 and a processor 40 (further shown in FIG. 3). The storage unit 30 stores a first relationship between a number of positions of the screen 10 and the electrodes 220. Each position corresponds to one electrode 220. The storage unit 30 further stores a tactile stimulation system 1. The system 1 includes a variety of modules executed by the processor 40 to provide the functions of the system 1. In this embodiment, the system 1 is executed by the processor 40 to detect touch operation on the screen 10 by a body member to be stimulated (e.g., a finger) and employ position information of the touch operation to energize the corresponding electrode 220 in the multilayer 20 to provide tactile stimulation. A detail description of the tactile stimulation multilayer 20 will be described as follows.

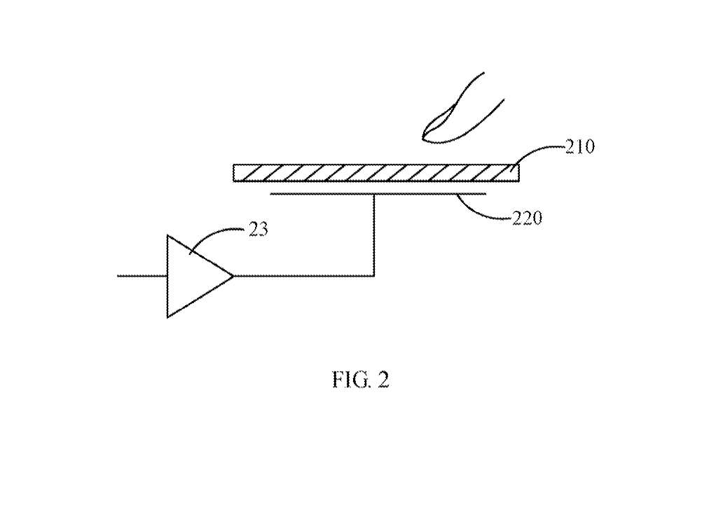

FIG. 2 shows that the multilayer 20 includes an insulation layer 21 and an electrode layer 22. The said electrodes 220 are included in the electrode layer 22. The electrodes 220 are connected to a power supply unit 23, and can be independently energized via the power supply unit 23. The insulation layer 21 includes a number of insulators 210, and each insulator 210 corresponds to one electrode 220. In the embodiment, the multilayer 20 is arranged under the screen 10, and the insulation layer 21 is arranged between the multilayer 20 and the electrode layer 22. Furthermore, when a body member which is a relatively good insulator when dry touches the multilayer 20, the body member and the multilayer 20 cooperatively form a imaginary capacitor. Then, the system 1 determines the position of the body member on the screen 10 and energizes the electrode 220 corresponding to the determined position via the power supply unit 23, thus, static charges generated on the body member because of a capacitive coupling between the determined electrode 220 and the body member, and the generated static charges flows to form electrical current which delivers a tactile stimulation to the body member.

FIG. 3 shows that in the embodiment, the system 1 includes a display module 11, a touch determining module 12, an analyzing module 13, and a control module 14.

The display module 11 displays a number of game objects set by a game when the electronic device 100 runs the game. Take a racing game for example, the game objects includes lanes, obstacles, tools to be selected, and awards. Each game object takes up a number of continuous positions of the screen 10. In the embodiment, a center position of the continuous positions is a target position employed to determine how to simulate the body member. It is notable that the target position is not limited to the center position of the continuous positions and can be varied as needed.

The touch determining module 12 determines each touched position of a slide operation according to touch signals from the screen 10. Specifically, each time when a slide operation is executed on the screen 10, different touched positions of the screen 10 are successively touched, thus, a new touched positions on the screen 10 may be different from a previous touched position along with the slide operation.

The analyzing module 13 determines whether a first distance between one touched position and one target position is less than a predetermined distance. If the first distance between one touched position and one target position is less than the predetermined distance, the touch operation is sufficiently close to one game object having the target position and one game object may be touched, thus a tactile stimulation may be provided to the body member.

The control module 14 determines an electrode 220 corresponding to the touched position according to the first relationship between the positions and the electrodes 220 if the first distance between one touched position and one target position is less than the predetermined distance, and then energizes the determined electrodes 220 via the power supply unit 23 with a predetermined electrical parameter. Thus, a tactile stimulation is provided to the body member touching the screen 10. In the embodiment, the electrical parameter is the amplitude or frequency of electrical current energizing the electrodes 220.

In the embodiment, the storage unit 30 further stores a second relationship between different game objects and electrical parameters. Each game object corresponds to one electrical parameter. After determining the electrode 220 corresponding to the touched position, the control module 14 further determines the electrical parameter corresponding to the game object which has the target position close to the touched position according to the second relationship between the game objects and electrical parameters, and then energizes the determined electrodes 220 with the determined electrical parameter. Therefore, different characteristics of the tactile stimulation can be generated when the body member touches different game objects.

The analyzing module 13 further determines whether a second distance between a new touched position of the slide operation and the target position is different from the first distance. The control module 14 further determines an electrode 220 corresponding to the new touched position if the second distance is different from the first distance, alters the predetermined electronic parameter according to a difference between the first and the second distances, and energizes the electrode 220 corresponding to the new touched position with the altered electrical parameter, thereby providing a varied tactile stimulation to the body member to inform the user whether the slide operation is a desired action.

In the embodiment, the control module 14 increases the predetermined electrical parameter energized to the electrode 220 corresponding to the new touched position when the second distance is greater than the first distance to enhance the tactile stimulation toward the game object, and decreases the predetermined electrical parameter energized to the electrode 220 corresponding to the new touched position when the second distance is less than the first distance to weaken the tactile stimulation away from the game object.

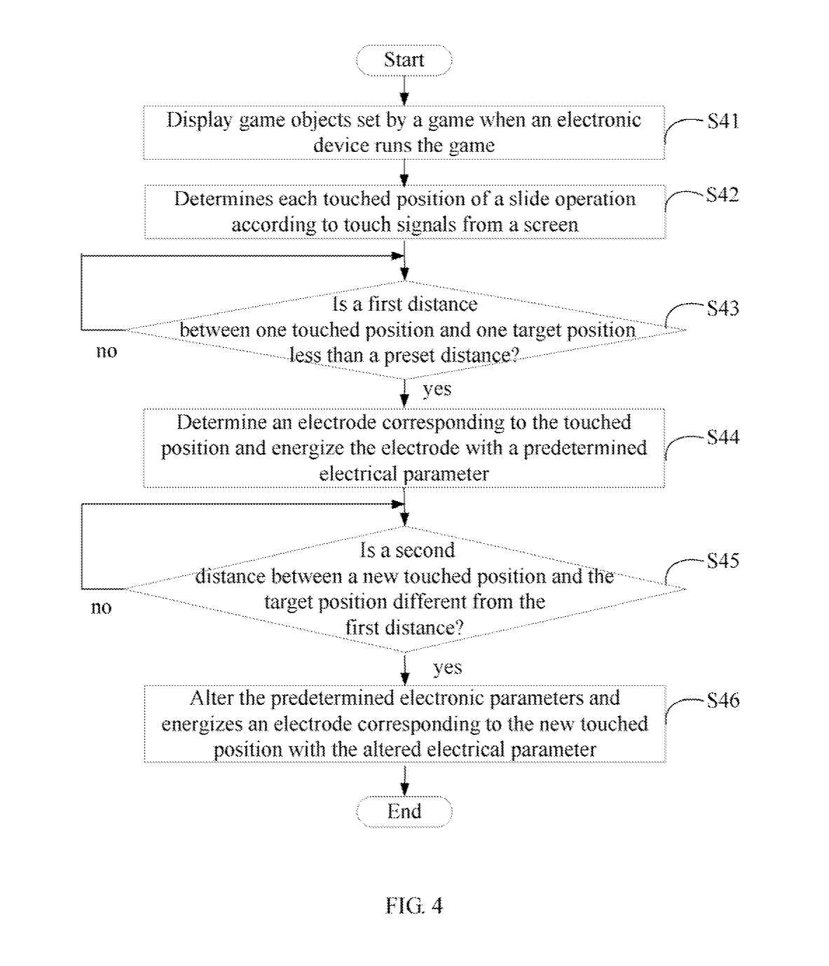

FIG. 4 is a flowchart of a method for providing tactile stimulation, in accordance with an exemplary embodiment.

In step S41, the display module 11 displays a number of game objects set by a game when the electronic device 100 runs the game. Each game includes a target position.

In step S42, the touch determining module 12 determines each touched position of a slide operation according to touch signals from the screen 10.

In step S43, the analyzing module 13 determines whether a first distance between one touched position and one target position is less than a predetermined distance, if yes, the procedure goes to step 44; otherwise, the procedure goes back to step S43.

In step S44, the control module 14 determines an electrode 220 corresponding to the touched position according to the first relationship between the positions and the electrodes 220, and energizes the determined electrode 220 via the power supply unit 23 with a predetermined electrical parameter. In the embodiment, the storage unit 30 further stores a second relationship between different game objects and electrical parameters, and each game object corresponds to one electrical parameter. The control module 14 further determines the electrical parameter corresponding to the game object which has the target position close to the touched position according the second relationship between the game objects and electrical parameters, and then energizes the determined electrode 220 with the determined electrical parameter.

In step S45, the analyzing module 13 whether a second distance between a new touched position of the slide operation and the target position is different from the first distance, if yes, the procedure goes to step S46; otherwise, the procedure goes back to step S45.

In step S46, the control module 14 determines an electrode 220 corresponding to the new touched position, alters the predetermined electronic parameters according to a difference between the first and the second distances, and energizes the electrode 220 corresponding to the new touched position with the altered electrical parameter. In the embodiment, the control module 14 increases the predetermined electrical parameter energized to the electrode 220 corresponding to the new touched position when the second distance is greater than the first distance to enhance the tactile stimulation toward the game object, and decreases the predetermined electrical parameter energized to the electrode 220 corresponding to the new touched position when the second distance is less than the first distance to weaken the tactile stimulation away from the game object.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being exemplary embodiments of the present disclosure.

1. An electronic device comprising:
a touch-sensitive screen;
a tactile stimulation multilayer connected to the touch-sensitive screen, the tactile stimulation multilayer comprising a plurality of electrodes;
a storage unit storing a plurality of modules and a first relationship between positions at the touch-sensitive screen and the electrodes, each position corresponding to one of the electrodes; and
a processor to execute a plurality of modules;
wherein the plurality of modules comprises:
a display module to display a plurality of game objects set by a game when the electronic device runs the game, wherein each game object comprises a target position;
a touch determining module to determine each touched position of a slide operation according to touch signals from the touch-sensitive screen;
an analyzing module to determine whether a first distance between one touched position and one target position is less than a predetermined distance; and further determine whether a second distance between a new touched position of the slide operation and the target position is different from the first distance; and
a control module to determine an electrode corresponding to the touched position according to the first relationship if the first distance is less than the predetermined distance and energize the determined electrode according to a predetermined electrical parameter; and further to determine an electrode corresponding to the new touched position if the second distance is different from the first distance, alter the predetermined electronic parameter according to a difference between the first and the second distances, and energize the electrode corresponding to the new touched position according to the altered electrical parameter.

2. The electronic device of claim 1, wherein the storage unit is further configured to store a second relationship between different game objects and electrical parameters, and each game object corresponds to one electrical parameter; and the control module is further configured to determine the electrical parameter corresponding to the game object which has the target position close to the touched position according to the second relationship between the game objects and electrical parameters and then energize the electrodes according to the determined electrical parameter.

3. The electronic device of claim 1, wherein the control module is further configured to increase the predetermined electrical parameter energized to the electrode corresponding to the new touched position when the second distance is greater than the first distance, and decrease the predetermined electrical parameter energized to the electrode corresponding to the new touched position when the second distance is less than the first distance.

4. The electronic device of claim 1, wherein each game object takes up a plurality of continuous positions at the touch-sensitive screen, and the target position is a center position of the continuous positions.

5. The electronic device of claim 1, wherein the electrical parameter is the amplitude or frequency of electrical current energizing the electrode.

6. A method for providing tactile stimulation applied in an electronic device, the electronic device comprising a touch-sensitive screen, a tactile stimulation multilayer, and a storage unit, the tactile stimulation multilayer being connected to the touch-sensitive screen, the tactile stimulation multilayer comprising a plurality of electrodes, the storage unit storing a first relationship between positions at the touch-sensitive screen and the electrodes, each position corresponding to one of the electrodes, the method comprising:
displaying a plurality of game objects set by a game when the electronic device runs the game, wherein each game object comprises a target position;
determining each touched position of a slide operation according to touch signals from the touch-sensitive screen;
determining whether a first distance between one touched position and one target position is less than a predetermined distance;
determining an electrode corresponding to the touched position according to the first relationship if the first distance is less than the predetermined distance and energizing the determined electrode according to a predetermined electrical parameter;
determining whether a second distance between a new touched position of the slide operation and the target position is different from the first distance; and
determining an electrode corresponding to the new touched position if the second distance is different from the first distance, altering the predetermined electronic parameter according to a difference between the first and the second distances, and energizing the electrode corresponding to the new touched position according to the altered electrical parameter.

7. A non-transitory computer-readable storage medium storing a plurality of modules, the plurality of modules comprising instructions executable by a processor of an electronic device to perform a method for providing tactile stimulation, the electronic device comprising a touch-sensitive screen and a tactile stimulation multilayer connected to the touch-sensitive screen, the tactile stimulation multilayer comprising a plurality of electrodes, the method comprising:
storing a plurality of modules and a first relationship between positions at the touch-sensitive screen and the electrodes, each position corresponding to one of the electrodes;
displaying a plurality of game objects set by a game when the electronic device runs the game, wherein each game object comprises a target position;
determining each touched position of a slide operation according to touch signals from the touch-sensitive screen;
determining whether a first distance between one touched position and one target position is less than a predetermined distance;
determining an electrode corresponding to the touched position according to the first relationship if the first distance is less than the predetermined distance and energizing the determined electrode according to a predetermined electrical parameter;
determining whether a second distance between a new touched position of the slide operation and the target position is different from the first distance; and
determining an electrode corresponding to the new touched position if the second distance is different from the first distance, altering the predetermined electronic parameter according to a difference between the first and the second distances, and energizing the electrode corresponding to the new touched position according to the altered electrical parameter.

8. The method of claim 6, wherein the storage unit is further configured to store a second relationship between different game objects and electrical parameters, and each game object corresponds to one electrical parameter; and the step of determining an electrode corresponding to the touched position according to the first relationship if the first distance is less than the predetermined distance and energizing the determined electrode according to a predetermined electrical parameter further comprises:
determining an electrode corresponding to the touched position according to the first relationship if the first distance is less than the predetermined distance;
determining an electrical parameter corresponding to the game object which has the target position close to the touched position according to the second relationship between the game objects and electrical parameters; and
energizing the electrodes according to the determined electrical parameter.

9. The method of claim 6 further comprising:
increasing the predetermined electrical parameter for the electrode corresponding to the new touched position when the second distance is greater than the first distance; and
decreasing the predetermined electrical parameter for the electrode corresponding to the new touched position when the second distance is less than the first distance.

10. The method of claim 6, wherein the target position is a center position of a plurality of continuous positions at the touch-sensitive screen taken up by each game object.

11. The method of claim 6, wherein the electrical parameter is the amplitude or frequency of electrical current energizing the electrode.

12. The non-transitory computer-readable storage medium of claim 7, wherein the method further comprises:
storing a second relationship between different game objects and electrical parameters, each game object corresponding to one electrical parameter;
determining an electrical parameter corresponding to the game object which has the target position close to the touched position according to the second relationship between the game objects and electrical parameters; and
energizing the electrodes according to the determined electrical parameter.

13. The non-transitory computer-readable storage medium of claim 7, wherein the step of energizing the electrode corresponding to the new touched position according to the altered electrical parameter further comprises:
increasing the predetermined electrical parameter for the electrode corresponding to the new touched position when the second distance is greater than the first distance; and
decreasing the predetermined electrical parameter for the electrode corresponding to the new touched position when the second distance is less than the first distance.

14. The non-transitory computer-readable storage medium of claim 7, wherein the target position is a center position of a plurality of continuous positions at the touch-sensitive screen taken up by each game object.

15. The non-transitory computer-readable storage medium of claim 7, wherein the electrical parameter is the amplitude or frequency of electrical current energizing the electrode.
